(19) United States
(12) Patent Application Publication
(10) Pub. No.: US 2025/0102957 A1
(43) Pub. Date: Mar. 27, 2025

(54) DEVELOPING DEVICE AND IMAGE FORMING APPARATUS

(71) Applicant: FUJIFILM Business Innovation Corp., Tokyo (JP)

(72) Inventors: Masanori KATO, Kanagawa (JP); Sadayuki TSUJINO, Kanagawa (JP); Daisuke UCHIMITSU, Kanagawa (JP); Shota IGAWA, Kanagawa (JP); Yoshihisa NAKAO, Kanagawa (JP)

(73) Assignee: FUJIFILM Business Innovation Corp., Tokyo (JP)

(21) Appl. No.: 18/591,629

(22) Filed: Feb. 29, 2024

(30) Foreign Application Priority Data
Sep. 27, 2023 (JP) 2023-164231

(51) Int. Cl. G03G 15/08

(52) U.S. Cl. CPC G03G 15/0891; G03G 15/0865

(57) ABSTRACT

A developing device includes a developer container that contains a developer, a developer carrier supported by the developer container and configured to carry the developer on a surface of the developer carrier, a first transporter configured to transport the developer in the developer container, disposed parallel to the developer carrier, and configured to supply the developer to the developer carrier, a second transporter configured to transport the developer in the developer container, disposed parallel to the first transporter, and configured to transport the developer in a direction opposite to a direction of the first transporter, a third transporter configured to transport the developer in the developer container, disposed parallel to the second transporter, and configured to transport the developer released from the developer carrier, a first container that contains the developer to be transported by the first transporter, a second container that contains the developer to be transported by the second transporter, a third container that contains the developer to be transported by the third transporter, a first partition that is disposed between the first container and the second container and separates the first container and the second container, a second partition that is disposed between the second container and the third container and separates the second container and the third container, a first inlet portion disposed on an upstream side of the first partition in a transport direction of the first transporter and configured to cause the developer to flow into the first container from the second container, a second inlet portion disposed on an upstream side of the first partition in a transport direction of the second transporter and configured to cause the developer to flow into the second container from the first container, and a third inlet portion disposed on an upstream side of the second partition in the transport direction of the second transporter and configured to cause the developer to flow into the second container from the third container.

### CROSS-REFERENCE TO RELATED APPLICATIONS

This application is based on and claims priority under 35 USC 119 from Japanese Patent Application No. 2023-164231 filed Sep. 27, 2023.

### BACKGROUND

### (i) Technical Field

The present disclosure relates to a developing device and an image forming apparatus.

### (ii) Related Art

Japanese Unexamined Patent Application Publication No. 2003-255700 (“0012”-“0021”, FIGS. 1 and 3) describes the following technology in an image forming apparatus that forms an image by electrostatically transferring and fixing a developer image on an image carrier to a medium such as paper.

Japanese Unexamined Patent Application Publication No. 2003-255700 describes a structure in which a first shielding plate (11) and a second shielding plate (12) are disposed on an upstream side and a downstream side in a rotational direction relative to an area where a photoconductor (2) and a developing sleeve (5) face each other. In Japanese Unexamined Patent Application Publication No. 2003-255700, voltages are applied to the first shielding plate (11) and the second shielding plate (12) to electrically return released and flying charged toner toward the developing sleeve (5).

### SUMMARY

Aspects of non-limiting embodiments of the present disclosure relate to a developing device in which a first transporter and a second transporter circulate a developer. In a structure in which a third transporter transports the developer released from a developer carrier, a shortcut of the released developer to the second transporter is suppressed compared with a case where a developer container of the third transporter and a developer container of the second transporter are not separated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device comprising: a developer container that contains a developer; a developer carrier supported by the developer container and configured to carry the developer on a surface of the developer carrier; a first transporter configured to transport the developer in the developer container, disposed parallel to the developer carrier, and configured to supply the developer to the developer carrier; a second transporter configured to transport the developer in the developer container, disposed parallel to the first transporter, and configured to transport the developer in a direction opposite to a direction of the first transporter; a third transporter configured to transport the developer in the developer container, disposed parallel to the second transporter, and configured to transport the developer released from the developer carrier; a first container that contains the developer to be transported by the first transporter; a second container that contains the developer to be transported by the second transporter; a third container that contains the developer to be transported by the third transporter; a first partition that is disposed between the first container and the second container and separates the first container and the second container; a second partition that is disposed between the second container and the third container and separates the second container and the third container; a first inlet portion disposed on an upstream side of the first partition in a transport direction of the first transporter and configured to cause the developer to flow into the first container from the second container; a second inlet portion disposed on an upstream side of the first partition in a transport direction of the second transporter and configured to cause the developer to flow into the second container from the first container; and a third inlet portion disposed on an upstream side of the second partition in the transport direction of the second transporter and configured to cause the developer to flow into the second container from the third container.

### BRIEF DESCRIPTION OF THE DRAWINGS

An exemplary embodiment of the present disclosure will be described in detail based on the following figures, wherein:

FIG. 1 illustrates an overall image forming apparatus of an exemplary embodiment;

FIG. 2 is an enlarged view of a visible image forming device of the exemplary embodiment;

FIG. 3 illustrates a developing device of the exemplary embodiment;

FIG. 4 is a sectional view taken along the line IV-IV in FIG. 3;

FIG. 5 is a sectional view taken along the line V-V in FIG. 3;

FIGS. 6A and 6B illustrate flows of a developer in the developing device, in which FIG. 6A illustrates a flow of the developer in a related-art structure, and FIG. 6B illustrates a flow of the developer in the exemplary embodiment;

FIG. 7 is a partially enlarged view of a facing component of the exemplary embodiment;

FIGS. 8A to 8D illustrate a relationship between the presence or absence of a facing member and a length, in which FIG. 8A illustrates a related-art structure in which the facing member is not provided and the length of a support is approximately equal to a frictional slide range, FIG. 8B illustrates a related-art structure in which the facing member is not provided and the length of the support is larger than the frictional slide range, FIG. 8C illustrates an example of the exemplary embodiment of the present disclosure in which the facing member is provided and the length of the support is approximately equal to the frictional slide range, and FIG. 8D illustrates another example of the exemplary embodiment of the present disclosure in which the facing member is provided and the length of the support is larger than the frictional slide range;

FIG. 9 illustrates a first modification of the exemplary embodiment in which the facing member is disposed on an upstream side of a developing area; and

FIG. 10 illustrates a second modification of the exemplary embodiment.

### DETAILED DESCRIPTION

An exemplary embodiment of the present disclosure is described with reference to the drawings. The exemplary embodiment of the present disclosure is not limited to the following exemplary embodiment.

To facilitate understanding of the following description, the drawings illustrate a fore-and-aft direction as an X-axis direction, a lateral direction as a Y-axis direction, and a vertical direction as a Z-axis direction. In the drawings, directions or sides indicated by arrows X, −X, Y, −Y, Z, and −Z are defined as “forward”, “rearward”, “rightward”, “leftward”, “upward”, and “downward”, or “front side”, “rear side”, “right side”, “left side”, “upper side”, and “lower side”, respectively.

In the drawings, a symbol represented by a dot in a circle means an arrow from back to front on the drawing sheet, and a symbol represented by a letter “x” in a circle means an arrow from front to back on the drawing sheet.

In the following description with reference to the drawings, illustrations other than members necessary to facilitate understanding are omitted as appropriate.

### Exemplary Embodiment

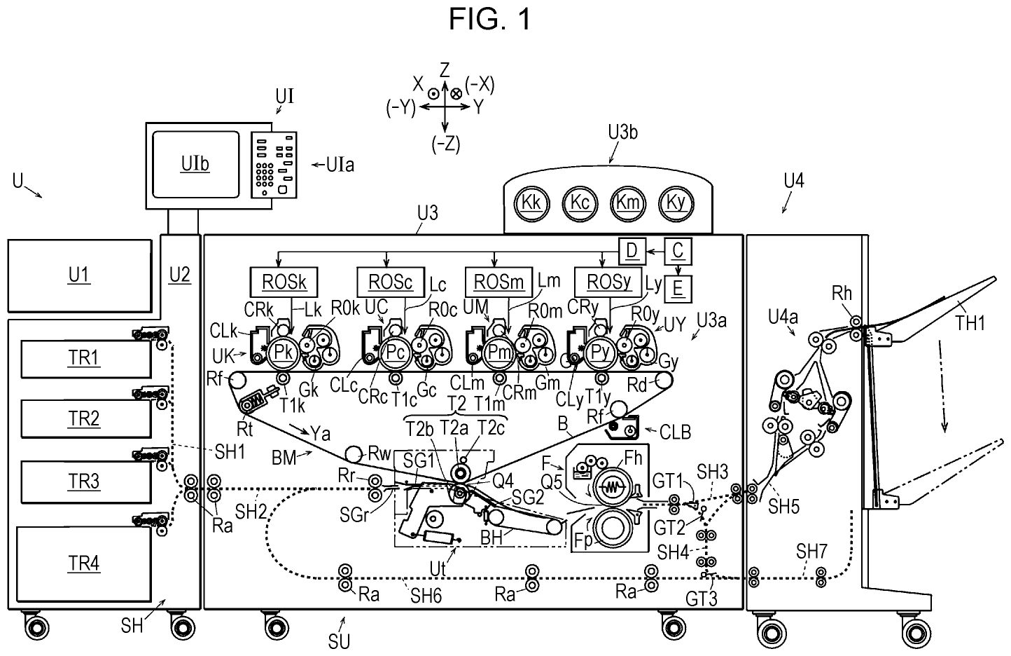

FIG. 1 illustrates an overall image forming apparatus of the exemplary embodiment.

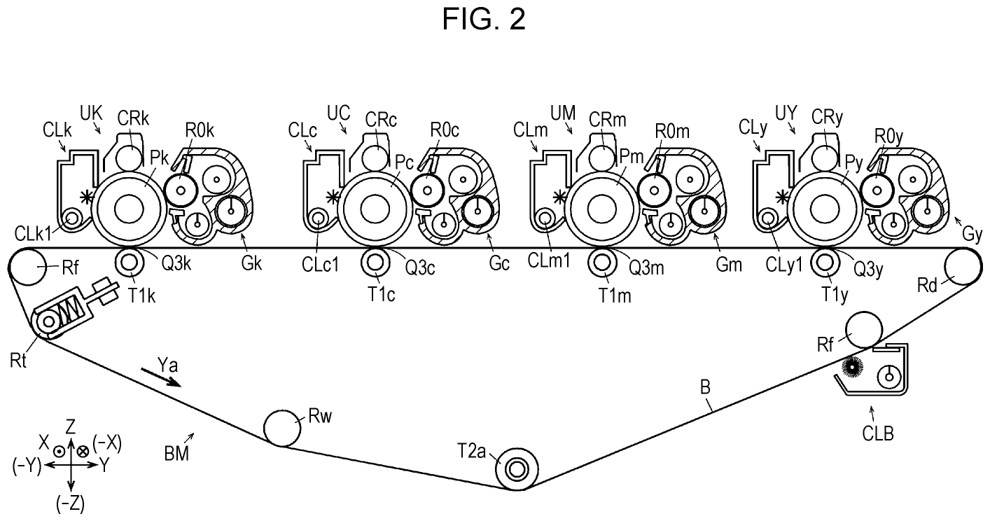

FIG. 2 is an enlarged view of a visible image forming device of the exemplary embodiment.

In FIG. 1, a copying machine U that is an example of the image forming apparatus includes a user interface UI that is an example of an operator, a scanner U1 that is an example of an image reading device, a feeder U2 that is an example of a medium feeding device, an image forming unit U3 that is an example of an image recording device, and a medium processing device U4.

### (User Interface UI)

The user interface UI includes input buttons UIa to be used for starting copying and setting the number of copies. The user interface UI further includes a display UIb that displays information input by using the input buttons UIa and the status of the copying machine U.

### (Feeder U2)

In FIG. 1, the feeder U2 includes a plurality of paper feed trays TR1, TR2, TR3, and TR4 that are examples of a medium container. The feeder U2 further includes a medium feed path SH1 along which recording paper S that is an example of an image recording medium is picked out from any one of the paper feed trays TR1 to TR4 and transported to the image forming unit U3.

### (Image Forming Unit U3 and Medium Processing Device U4)

In FIG. 1, the image forming unit U3 includes an image recorder U3a that records an image on the recording paper S transported from the feeder U2 based on a document image read by the scanner U1.

In FIGS. 1 and 2, a latent image forming device driving circuit D of the image forming unit U3 outputs, based on image information input from the scanner U1, driving signals to yellow (Y), magenta (M), cyan (C), and black (K) latent image forming devices ROSy, ROSm, ROSc, and ROSk at preset timings. Photoconductor drums Py, Pm, Pc, and Pk that are examples of an image carrier are disposed below the latent image forming devices ROSy to ROSK that are examples of a writer, respectively.

The surfaces of the rotating photoconductor drums Py to Pk are uniformly charged by charging rollers CRy, CRm, CRc, and CRk that are examples of a charger, respectively. Electrostatic latent images are formed on the charged surfaces of the photoconductor drums Py to Pk by laser beams Ly, Lm, Lc, and Lk that are examples of latent image writing light and output from the latent image forming devices ROSy to ROSK, respectively. The electrostatic latent images on the surfaces of the photoconductor drums Py to Pk are developed into yellow (Y), magenta (M), cyan (C), and black (K) toner images that are examples of a visible image by developing devices Gy, Gm, Gc, and Gk that are examples of a developing unit, respectively.

In the developing devices Gy to Gk, developers consumed by development are supplied from toner cartridges Ky, Km, Kc, and Kk that are examples of a developer container, respectively. The toner cartridges Ky to Kk are removably mounted on a developer supply device U3b.

The toner images on the surfaces of the photoconductor drums Py to Pk are sequentially transferred and laid over one another in first transfer areas Q3y, Q3m, Q3c, and Q3k on an intermediate transfer belt B that is an example of an intermediate transferrer by first transfer rollers T1y, T1m, T1c, and T1k that are examples of a first transferrer, respectively. Thus, a color toner image that is an example of a multicolor visible image is formed on the intermediate transfer belt B. The color toner image formed on the intermediate transfer belt B is transported to a second transfer area Q4.

In a case of black image information alone, the black photoconductor drum Pk and the black developing device Gk are used to form a black toner image.

On the photoconductor drums Py to Pk after the first transfer, drum cleaners CLy, CLm, CLc, and CLk that are examples of an image carrier cleaner remove residues such as residual developers or paper dust on the surfaces, respectively.

In the exemplary embodiment, the photoconductor drum Pk, the charging roller CRk, and the drum cleaner CLK are integrated into a black photoconductor unit UK that is an example of an image carrier unit. In the other colors (yellow, magenta, and cyan) as well, the photoconductor drums Py, Pm, and Pc, the charging rollers CRy, CRm, and CRc, and the drum cleaners CLy, CLm, and CLc constitute photoconductor units UY, UM, and UC, respectively.

The black photoconductor unit UK and the developing device Gk including a developing roller R0K that is an example of a developer carrier constitute a black image former UK+Gk. Similarly, the yellow, magenta, and cyan photoconductor units UY, UM, and UC and the developing devices Gy, Gm, and Gc including developing rollers R0y, R0m, and R0c constitute yellow, magenta, and cyan image formers UY+Gy, UM+Gm, and UC+Gc, respectively.

A belt module BM that is an example of the intermediate transferrer is disposed below the photoconductor drums Py to Pk. The belt module BM includes the intermediate transfer belt B that is an example of the image carrier, a driving roller Rd that is an example of an intermediate transferrer driver, a tension roller Rt that is an example of a tensile force applier, a walking roller Rw that is an example of a meandering preventer, a plurality of idler rollers Rf that is examples of a driven component, a backup roller T2a that is an example of a facing component, and the first transfer rollers T1y to T1k. The intermediate transfer belt B is supported while being rotatable in an arrow Ya direction.

In the exemplary embodiment, the yellow, magenta, and cyan first transfer rollers T1y, T1m, and T1c are supported while being approachable to or separable from the photoconductor drums Py, Pm, and Pc, respectively. In multicolor printing, the yellow, magenta, and cyan first transfer rollers T1y, T1m, and T1c approach the photoconductor drums Py to Pc, respectively, to nip the intermediate transfer belt B at a predetermined contact pressure. In monochrome printing using black alone, the first transfer rollers T1y, T1m, and T1c are separated from the photoconductor drums Py to Pc, respectively.

A second transfer unit Ut is disposed below the backup roller T2a. The second transfer unit Ut includes a second transfer roller T2b that is an example of a second transfer member. The second transfer area Q4 is an area where the second transfer roller T2b is in contact with the intermediate transfer belt B. The backup roller T2a faces the second transfer roller T2b across the intermediate transfer belt B. A contact roller T2c that is an example of a power supplier is in contact with the backup roller T2a. A second transfer voltage having the same polarity as a toner charging polarity is applied to the contact roller T2c.

The backup roller T2a, the second transfer roller T2b, and the contact roller T2c constitute a second transferrer T2.

The second transfer unit Ut of the exemplary embodiment is approachable to or separable from the intermediate transfer belt B. Depending on the type of the recording paper S in use, the second transfer unit Ut moves to change the contact pressure between the second transfer roller T2b and the intermediate transfer belt B. For example, in a case of thick paper, the contact pressure is reduced compared with a case of plain paper to reduce an impact when the leading edge of the thick paper enters the second transfer area Q4.

A medium transport path SH2 is disposed below the belt module BM. The recording paper S fed through the medium feed path SH1 of the feeder U2 is transported to registration rollers Rr that are an example of a transport timing adjuster by transport rollers Ra that are an example of a medium transporter. The registration rollers Rr transport the recording paper S downstream in synchronization with a timing when the toner image formed on the intermediate transfer belt B is transported to the second transfer area Q4. The recording paper S sent out by the registration rollers Rr is guided by a registration paper guide SGr and a pre-transfer paper guide SG1 and transported to the second transfer area Q4.

The toner image on the intermediate transfer belt B is transferred onto the recording paper S by the second transferrer T2 when passing through the second transfer area Q4. In the case of a color toner image, the toner images firstly transferred onto the surface of the intermediate transfer belt B and laid over one another are secondly transferred collectively onto the recording paper S.

The first transfer rollers T1y to T1k, the second transferrer T2, and the intermediate transfer belt B constitute a transfer device T1y−T1k+T2+B that is an example of a transferrer.

The intermediate transfer belt B after the second transfer is cleaned by a belt cleaner CLB that is an example of an intermediate transferrer cleaner disposed on a downstream side of the second transfer area Q4. The belt cleaner CLB removes, from the intermediate transfer belt B, residues such as paper dust or developers that remain without being transferred in the second transfer area Q4.

The recording paper S onto which the toner image is transferred is guided by a post-transfer paper guide SG2 and sent to a belt transport device BH that is an example of the medium transporter. The belt transport device BH transports the recording paper S to a fixing device F.

The fixing device F that is an example of a fixer includes a heating roller Fh that is an example of a heater, and a pressure roller Fp that is an example of a pressurizer. The recording paper S is transported to a fixing area Q5 where the heating roller Fh is in contact with the pressure roller Fp. The toner image on the recording paper S is fixed by being heated and pressurized by the fixing device F when passing through the fixing area Q5.

The image formers UY+Gy to UK+Gk, the transfer device T1y−T1k+T2+B, and the fixing device F constitute the image recorder U3a that is an example of an image former of the exemplary embodiment.

A switching gate GT1 that is an example of a switcher is provided on a downstream side of the fixing device F. The switching gate GT1 selectively switches the recording paper S having passed through the fixing area Q5 into an output path SH3 toward the medium processing device U4 or into a reversing path SH4. The recording paper S transported to the output path SH3 is transported to a paper transport path SH5 of the medium processing device U4. A curl correction member U4a that is an example of a warp corrector is disposed on the paper transport path SH5. The curl correction member U4a corrects a warp, that is, a curl of the transported recording paper S. The recording paper S having undergone the curl correction is output, with its image-fixed side oriented upward, to an output tray TH1 that is an example of a medium outputter by output rollers Rh that are an example of a medium output member.

The recording paper S transported toward the reversing path SH4 of the image forming unit U3 by the switching gate GT1 is transported to the reversing path SH4 of the image forming unit U3 through a second gate GT2 that is an example of the switcher.

To output the recording paper S with its image-fixed side oriented downward, the transport direction of the recording paper S is reversed after the trailing edge of the recording paper S in the transport direction has passed through the second gate GT2. The second gate GT2 of the exemplary embodiment is a thin-film elastic member. The second gate GT2 causes the recording paper S to temporarily pass when it is transported toward the reversing path SH4, and guides the recording paper S toward the transport paths SH3 and SH5 when the recording paper S is reversed, that is, switched back. The switched-back recording paper S is output to the output tray TH1 through the curl correction member U4a with its image-fixed side oriented downward.

A circulation path SH6 is connected to the reversing path SH4 of the image forming unit U3. A third gate GT3 that is an example of the switcher is disposed at the connecting portion. The downstream end of the reversing path SH4 is connected to a reversing path SH7 of the medium processing device U4.

The recording paper S transported to the reversing path SH4 through the switching gate GT1 is transported toward the reversing path SH7 of the medium processing device U4 by the third gate GT3. The third gate GT3 of the exemplary embodiment is a thin-film elastic member similarly to the second gate GT2. The third gate GT3 causes the recording paper S to temporarily pass when it is transported along the reversing path SH4, and guides the recording paper S toward the circulation path SH6 when the recording paper S is switched back.

The recording paper S transported to the circulation path SH6 is sent again to the second transfer area Q4 through the medium transport path SH2, and printing is performed on the second side.

The elements SH1 to SH7 constitute a paper transport path SH. The elements SH, Ra, Rr, Rh, SGr, SG1, SG2, BH, and GT1 to GT3 constitute a paper transport device SU of the exemplary embodiment.

### (Developing Device)

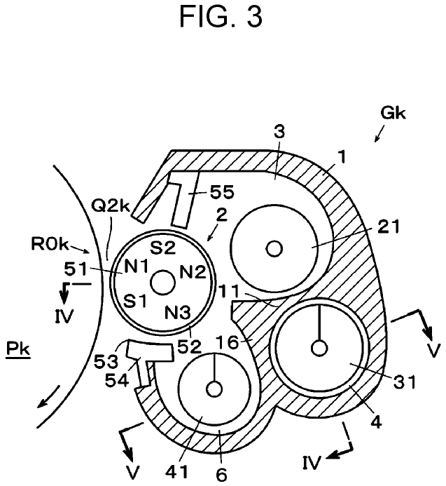

FIG. 3 illustrates the developing device of the exemplary embodiment.

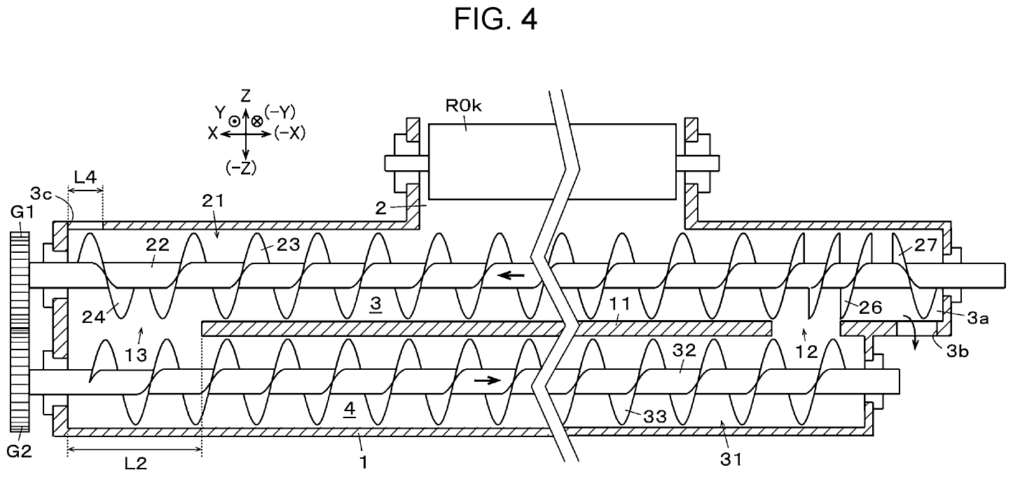

FIG. 4 is a sectional view taken along the line IV-IV in FIG. 3.

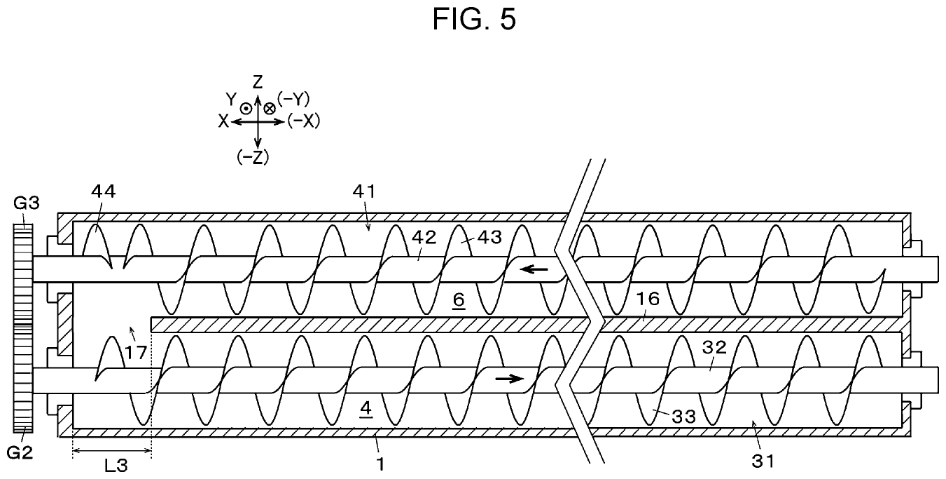

FIG. 5 is a sectional view taken along the line V-V in FIG. 3.

The following description is directed to the black developing device Gk and description of the yellow, magenta, and cyan developing devices Gy, Gm, and Gc is omitted because the developing devices Gy to Gk have similar structures.

In FIGS. 3 to 5, the developing device Gk that is an example of the developing unit includes a developing container 1 that is an example of a container. In the exemplary embodiment, the developing container 1 contains a two-component developer composed of a negatively charged toner and a positively charged magnetic carrier.

The developing container 1 has a developing chamber 2 that houses the developing roller R0K. The developing chamber 2 extends along an axial direction of the developing roller R0K. On the right side of the developing chamber 2, a supply chamber 3 that is an example of a first container is formed adjacent and parallel to the developing chamber 2.

In FIG. 4, a discharge chamber 3a extending rearward is formed at the rear end of the supply chamber 3. A discharge port 3b that is an example of a discharge portion is formed on the lower rear end surface of the discharge chamber 3a. A replenishment port 3c that is an example of a fourth inlet portion is formed on the upper front end surface of the supply chamber 3. A new developer is supplied from the toner cartridge Kk to the replenishment port 3c.

In FIGS. 3 to 5, an agitation chamber 4 that is an example of a second container is formed adjacent and parallel to the supply chamber 3. A return chamber 6 that is an example of a third container is formed between the developing chamber 2 and the agitation chamber 4 adjacent and parallel to them. The developer is contained in the developing chamber 2, the supply chamber 3, the agitation chamber 4, and the return chamber 6.

In FIGS. 3 and 4, the developing chamber 2 and the supply chamber 3 are connected in the entire area in the axial direction of the developing roller R0K. That is, a partition that blocks the flow of the developer is not provided between the developing chamber 2 and the supply chamber 3. The supply chamber 3 and the agitation chamber 4 are separated by a first partition wall 11 that is an example of a first partition. A first inlet 12 that is an example of a first inlet portion is formed at the rear end of the first partition wall 11. A second inlet 13 that is an example of a second inlet portion is formed at the front end of the first partition wall 11. Through the first inlet 12 and the second inlet 13, the developer may flow between the supply chamber 3 and the agitation chamber 4.

In FIGS. 3 and 5, the agitation chamber 4 and the return chamber 6 are separated by a second partition wall 16 that is an example of a second partition. A third inlet 17 that is an example of a third inlet portion is formed at the front end of the second partition wall 16. No inlet portion is provided at the rear end of the second partition wall 16. Through the third inlet 17, the developer may flow between the agitation chamber 4 and the return chamber 6. In the exemplary embodiment, the developing chamber 2 and the return chamber 6 are connected in the entire area in the axial direction of the developing roller R0K. Thus, the developer may flow in the entire area in the axial direction between the developing chamber 2 and the return chamber 6.

The supply chamber 3 houses a supply auger 21 that is an example of a first transporter. The supply auger 21 has a first rotational shaft 22. Both ends of the first rotational shaft 22 are rotatably supported by the developing container 1. A first gear G1 that is an example of a driven component is supported at one outer end of the first rotational shaft 22.

A first forward transport blade 23 that is an example of a forward transporter is supported by the first rotational shaft 22. In the exemplary embodiment, the first forward transport blade 23 is a helical blade in a predetermined screw direction. During the rotation of the first rotational shaft 22, the first forward transport blade 23 transports the developer from rear to front in the supply chamber 3. That is, the first forward transport blade 23 transports the developer from the first inlet 12 to the second inlet 13.

A first reverse transport blade 24 is supported at the front end of the first rotational shaft 22 and positioned on the front side relative to the first forward transport blade 23. The first reverse transport blade 24 is a helical blade in a screw direction opposite to that of the first forward transport blade 23. During the rotation of the first rotational shaft 22, the first reverse transport blade 24 transports the developer rearward in the supply chamber 3. The first reverse transport blade 24 applies a transport force in a reverse direction to the developer transported forward by the first forward transport blade 23 to suppress forward movement of the developer and advance the inflow of the developer into the agitation chamber 4 through the second inlet 13.

A first auxiliary forward transport blade 26 is supported at the rear of the first rotational shaft 22 and positioned on the rear side relative to the first forward transport blade 23. The first auxiliary forward transport blade 26 has a helix in the same screw direction as that of the first forward transport blade 23 and has a smaller helix pitch (axial advancing distance per rotation of the first rotational shaft 22 in the circumferential direction) than the first forward transport blade 23. During the rotation of the first rotational shaft 22, the first auxiliary forward transport blade 26 transports the developer forward in the supply chamber 3 with a smaller transport force than that of the first forward transport blade 23. Thus, part of the developer flowing into the supply chamber 3 through the first inlet 12 flows into the discharge chamber 3a at the rear over the first auxiliary forward transport blade 26.

A discharge transport blade 27 is supported at the rear end of the first rotational shaft 22 and positioned on the rear side relative to the first auxiliary forward transport blade 26. The discharge transport blade 27 is a helical blade in a screw direction opposite to that of the first forward transport blade 23. During the rotation of the first rotational shaft 22, the discharge transport blade 27 transports the developer in the supply chamber 3, especially the discharge chamber 3a, toward the discharge port 3b at the rear.

The agitation chamber 4 houses an agitation auger 31 that is an example of a second transporter. The agitation auger 31 has a second rotational shaft 32. Both ends of the second rotational shaft 32 are rotatably supported by the developing container 1. A second gear G2 that is an example of the driven component is supported at one outer end of the second rotational shaft 32. In the exemplary embodiment, the second gear G2 meshes with the first gear G1.

A second forward transport blade 33 that is an example of the forward transporter is supported by the second rotational shaft 32. In the exemplary embodiment, the second forward transport blade 33 is a helical blade in the same screw direction as that of the first forward transport blade 23. During the rotation of the second rotational shaft 32, the second forward transport blade 33 transports the developer from front to rear in the agitation chamber 4. That is, the second forward transport blade 33 transports the developer from the second inlet 13 to the first inlet 12.

The return chamber 6 houses a return auger 41 that is an example of a third transporter. The return auger 41 has a third rotational shaft 42. Both ends of the third rotational shaft 42 are rotatably supported by the developing container 1. A third gear G3 that is an example of the driven component is supported at one outer end of the third rotational shaft 42. In the exemplary embodiment, the third gear G3 meshes with the second gear G2.

A third forward transport blade 43 that is an example of the forward transporter is supported by the third rotational shaft 42. In the exemplary embodiment, the third forward transport blade 43 is a helical blade in the same screw direction as that of the first forward transport blade 23. During the rotation of the third rotational shaft 42, the third forward transport blade 43 transports the developer from rear to front in the return chamber 6. That is, the third forward transport blade 43 transports the developer in the return chamber 6 to the second inlet 13.

A third reverse transport blade 44 is supported at the front end of the third rotational shaft 42 and positioned on the front side relative to the third forward transport blade 43. The third reverse transport blade 44 is a helical blade in a screw direction opposite to that of the third forward transport blade 43. During the rotation of the third rotational shaft 42, the third reverse transport blade 44 applies a force for transporting the developer rearward in the return chamber 6. The third reverse transport blade 44 applies a transport force in a reverse direction to the developer transported forward by the third forward transport blade 43 to suppress forward movement of the developer and advance the inflow of the developer into the agitation chamber 4 through the third inlet 17.

As described above, the developer in the agitation chamber 4 of the developing container 1 is transported rearward while being agitated by the rotation of the agitation auger 31. The developer transported to the rear end of the agitation chamber 4 flows into the supply chamber 3 through the first inlet 12. The developer in the supply chamber 3 is transported while being agitated from rear to front by the rotation of the supply auger 21. At this time, part of the developer in the supply chamber 3 is supplied to the developing roller R0K. The developer transported to the front end in the supply chamber 3 flows into the agitation chamber 4 through the second inlet 13. Thus, the developer circulates through the supply chamber 3 and the agitation chamber 4.

The developer that has been supplied to the developing roller R0K but has not been used for development is returned to the return chamber 6. The developer in the return chamber 6 is transported while being agitated forward by the return auger 41. The developer transported to the front end of the return chamber 6 flows into the agitation chamber 4 through the third inlet 17. Thus, the developer returned from the developing roller R0K also circulates and is used again.

When the developer is consumed along with development, a new developer is supplied through the replenishment port 3c. The new developer supplied through the replenishment port 3c flows into the agitation chamber 4 from the front end of the supply chamber 3 through the second inlet 13. Then, the developer is transported while being agitated by the agitation auger 31 in the agitation chamber 4 and is used for development.

Part of the developer flowing into the discharge chamber 3a is discharged through the discharge port 3b.

In the exemplary embodiment, the front end of the second partition wall 16 is positioned on the front side relative to the front end of the first partition wall 11. Thus, a width (inflow range) L2 of the second inlet 13 is larger than a width (inflow range) L3 of the third inlet 17. In other words, the downstream end (rear end) of the third inlet 17 in the developer transport direction of the agitation auger 31 is positioned on the upstream side (front side) relative to the downstream end (rear end) of the second inlet 13. The third inlet 17 is positioned at the upstream part (front part) of the inflow range L2 of the second inlet 13 in the developer transport direction of the agitation auger 31. That is, the third inlet 17 does not overlap the downstream part of the inflow range L2 of the second inlet 13 in the developer transport direction of the agitation auger 31.

In the exemplary embodiment, the replenishment port 3c is disposed at a position corresponding to the third inlet 17 in the fore-and-aft direction, that is, in the developer transport direction of the supply auger 21 or the agitation auger 31. In the exemplary embodiment, a width L4 of the replenishment port 3c is smaller than the width of the third inlet 17. Therefore, the replenishment port 3c is positioned to overlap the third inlet 17. Thus, the downstream end (rear end) of the replenishment port 3c in the developer transport direction of the agitation auger 31 is positioned on the upstream side (front side) relative to the downstream end (rear end) of the second inlet 13.

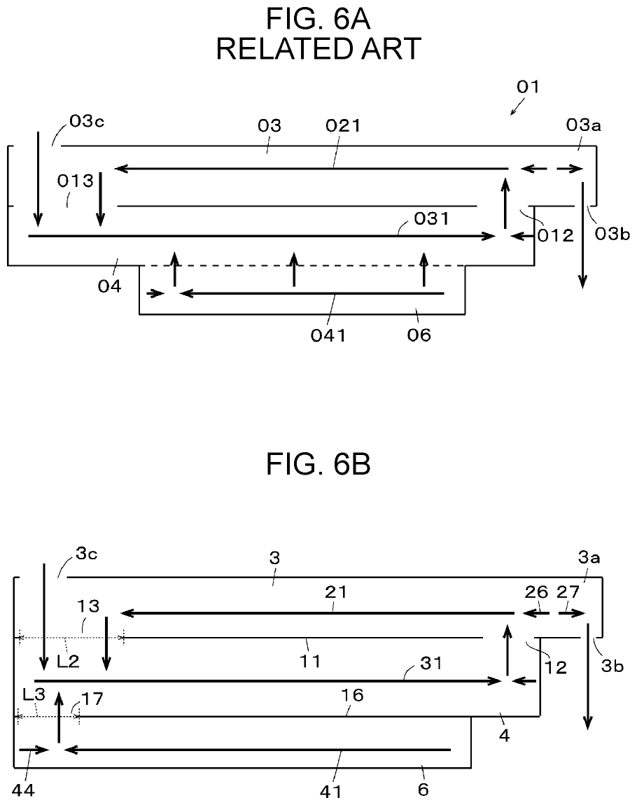

FIGS. 6A and 6B illustrate flows of the developer in the developing device. FIG. 6A illustrates a flow of the developer in a related-art structure. FIG. 6B illustrates a flow of the developer in the exemplary embodiment.

In a related-art developing container 01 of FIG. 6A, a return chamber 06 and an agitation chamber 04 are not separated. Therefore, the developer returned to the return chamber 06 from the developing roller is sequentially returned to the agitation chamber 04 at the return positions in the axial direction of the developing roller. Thus, it is likely that the developer returned to the return chamber 06 near a first inlet 012 is immediately transported to the first inlet 012 from the agitation chamber 04 and is used again by the developing roller. Accordingly, deterioration of the developer is likely to advance. It takes a long period until the developer returned away from the first inlet 012 is used again by the developing roller. Thus, the developer is likely to deteriorate unevenly. When the amount of the developer transported with a shortcut to the vicinity of the first inlet 012 increases, the deterioration is likely to advance and its unevenness is likely to increase. When the unevenness of the developer deterioration increases, the image quality may decrease.

In the developing device Gk of the exemplary embodiment, the return chamber 6 and the agitation chamber 4 are separated by the second partition wall 16. Therefore, all the developer returned to the return chamber 6 from the developing roller R0K is returned to the agitation chamber 4 through the third inlet 17 as illustrated in FIG. 6B.

In the related-art structure, the amount of the developer circulating through the agitation chamber 04 is larger than the amount of the developer returned from the return chamber 06. Therefore, the developer may flow back to the return chamber 06 from the agitation chamber 04. When the backflow occurs, the return chamber 06 may become full of the developer or the developer may be hindered from flowing into the agitation chamber 04 from the return chamber 06. When the return chamber 06 is full of the developer, the developer is not easily returned to the return chamber 06 from the developing roller. In this case, the developer once separated away from the developing roller adheres again, and the developer that is not sufficiently agitated or charged is used again. When the developer that is not sufficiently charged is used, the image quality may decrease or the released developer may increase.

In the exemplary embodiment, the third inlet 17 is positioned at the upstream part (front part) of the inflow range L2 of the second inlet 13 in the developer transport direction of the agitation auger 31. Therefore, the majority of the developer flowing into the agitation chamber 4 from the supply chamber 3 flows in on the rear side of the second inlet 13. Thus, the amount of the developer in the range of the third inlet 17 on the rear side of the second inlet 13 is relatively small.

In the exemplary embodiment, the replenishment port 3c is disposed at the position corresponding to the third inlet 17. The developer returned to the agitation chamber 4 from the return chamber 6 is used once for development. Therefore, the developer is charged but its concentration has decreased. The new developer supplied through the replenishment port 3c has high concentration but the charging may be insufficient due to insufficient agitation. In the exemplary embodiment, the low-concentration developer flowing through the third inlet 17 and the new developer flowing through the replenishment port 3c easily join each other at the upstream end of the agitation chamber 4. The low-concentration developer and the new developer are mixed together by being agitated by the agitation auger 31 before the developers are transported to the first inlet 12 at the downstream end of the agitation chamber 4. Therefore, the developer easily recovers its concentration and is easily charged sufficiently. In the related-art structure illustrated in FIG. 6A, the low-concentration developer with a shortcut is unlikely to recover its concentration and is likely to be mixed with the new developer insufficiently. A developing failure is likely to occur when the developer does not recover its concentration or the charging is insufficient.

In FIG. 3, the developing roller R0K of the exemplary embodiment includes a fixed magnet roller 51 that is an example of a magnet component, and a rotary developing sleeve 52 that is an example of a rotary component. The developer is attracted and carried on the surface of the developing sleeve 52 by a magnetic force of the magnet roller 51, and is transported to a developing area Q2k by the rotation of the developing sleeve 52.

The magnet roller 51 has a developing magnetic pole S1 at a position corresponding to the developing area Q2k where the magnet roller 51 faces the photoconductor drum Pk. A transport magnetic pole N1 is positioned on the upstream side of the developing magnetic pole S1 in the rotational direction of the developing sleeve 52. A trimming magnetic pole S2 that is an example of a layer thickness regulating magnetic pole is positioned on the upstream side of the transport magnetic pole N1 in the rotational direction of the developing sleeve 52. A pickup magnetic pole N2 that is an example of an attraction magnetic pole is positioned on the upstream side of the trimming magnetic pole S2 in the rotational direction of the developing sleeve 52 to face the supply auger 21. A pickoff magnetic pole N3 that is an example of a separation magnetic pole is positioned on the upstream side of the pickup magnetic pole N2 and on the downstream side of the developing magnetic pole S1 in the rotational direction of the developing sleeve 52.

The developer in the supply chamber 3 is carried on the developing sleeve 52 by a magnetic force of the pickup magnetic pole N2.

A trimmer 55 that is an example of a layer thickness regulating member is positioned to face the trimming magnetic pole S2. The trimmer 55 regulates the layer thickness of the developer adhering to the developing sleeve 52. Thus, the developer having a predetermined layer thickness is carried on the surface of the developing sleeve 52 that has passed over the position of the trimmer 55.

The developer is sent to the developing area Q2k by the rotation of the developing sleeve 52 while being carried on the developing sleeve 52 by a magnetic field between the trimming magnetic pole S2 and the transport magnetic pole N1 and a magnetic field between the transport magnetic pole N1 and the developing magnetic pole S1.

The developer that has passed through the developing area Q2k is sent toward the return chamber 6 while being carried on the developing sleeve 52 between the developing magnetic pole S1 and the pickoff magnetic pole N3. When the developer approaches the position between the pickoff magnetic pole N3 and the pickup magnetic pole N2, the developer is separated from the developing sleeve 52 and flows into the return chamber 6 by a magnetic field between the pickoff magnetic pole N3 and the pickup magnetic pole N2 having the same polarity.

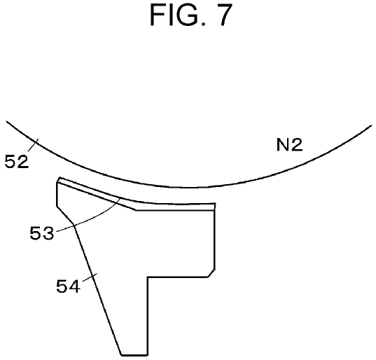

FIG. 7 is a partially enlarged view of a facing component of the exemplary embodiment.

In FIGS. 3 and 7, a charging film 53 that is an example of the facing member is supported by the developing container 1 that is an example of a developer container. The charging film 53 faces the developing sleeve 52 on the downstream side of the developing area Q2k in the rotational direction of the developing sleeve 52. The charging film 53 is supported by a film support 54 that is an example of a support provided on the downstream side of the developing area Q2k in the rotational direction of the developing sleeve 52. The film support 54 is supported by the developing container 1.

The charging film 53 and the developing sleeve 52 are disposed with a clearance that allows the developer carried on the developing sleeve 52 to frictionally slide against the charging film 53.

The charging film 53 is made of a material having the same polarity as the developer in terms of chargeability. When the charging polarity of the developer is a negative polarity, the charging film 53 may be made of a material having a negative polarity in terms of chargeability. Examples of the material having a negative polarity in terms of chargeability include a fluororesin such as polytetrafluoroethylene (PTFE), polyimide (PI), polypropylene (PP), polyvinyl chloride (PVC), and polyoxymethylene (POM) (polyacetal).

When the charging film 53 frictionally slides against the developer, the charging film 53 is charged triboelectrically. When the charging film 53 is charged triboelectrically, an electric field is generated due to the relationship between the charging potential of the charging film 53 and the developing bias of the developing roller R0K. The experiments conducted by the inventors show that the charging film 53 made of, for example, PTFE has a charging potential of −1000 [V] or higher. In a case where the developing bias is −600 [V], the developing sleeve 52 is positive (+) and the charging film 53 is negative (−). Therefore, the negatively charged developer is subjected to a force for electrostatically attracting the developer toward the developing sleeve 52. Thus, the developer released and flying during the development in the developing area Q2k is easily attracted toward the developing sleeve 52.

In the exemplary embodiment, the charging film 53 frictionally slides against the developer before separation from the developing sleeve 52. Therefore, the charging film 53 is positioned on the upstream side in the rotational direction of the developing sleeve 52 relative to the pickoff magnetic pole N3.

The length of the charging film 53 along the rotational direction of the developing sleeve 52 is set to a length associated with a width at which the developer frictionally slides. The developer is along a magnetic flux of the magnetic field. As the developer is closer to the magnetic pole S1 or N3, a so-called magnetic brush of the developer is likely to become longer. At a middle position between the magnetic poles S1 and N3, the magnetic brush of the developer is likely to become shorter. Therefore, the developer does not easily frictionally slide against the charging film 53 in the range in which the magnetic brush of the developer is short, and easily frictionally slides against the charging film 53 in the range in which the magnetic brush of the developer is long. The charging film 53 of the exemplary embodiment is disposed in a frictional slide range determined in advance through experiments etc., and the length of the charging film 53 is set to a length associated with the frictional slide range. For example, the charging film 53 of the exemplary embodiment, including the film support 54, is positioned on the downstream side close to the pickoff magnetic pole N3.

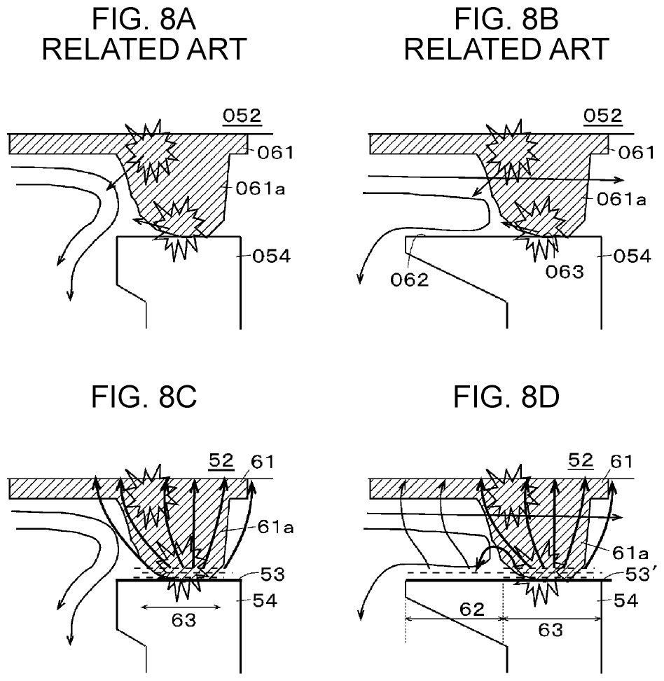

FIGS. 8A to 8D illustrate a relationship between the presence or absence of the facing member and the length. FIG. 8A illustrates a related-art structure in which the facing member is not provided and the length of the support is approximately equal to the frictional slide range. FIG. 8B illustrates a related-art structure in which the facing member is not provided and the length of the support is larger than the frictional slide range. FIG. 8C illustrates an example of the exemplary embodiment of the present disclosure in which the facing member is provided and the length of the support is approximately equal to the frictional slide range. FIG. 8D illustrates another example of the exemplary embodiment of the present disclosure in which the facing member is provided and the length of the support is larger than the frictional slide range.

In the structure without the charging film in FIG. 8A, when a magnetic brush 061a of a developer 061 comes into contact with a support 054, the developer 061 is likely to be separated by a physical force at the time of frictional slide. Therefore, the developer is likely to be released. When the magnetic brush 061a is positioned on the downstream side of the support 054 as illustrated in FIG. 8B, a non-frictional slide area 062 is present on the upstream side. Therefore, part of the released developer remains in the non-frictional slide area 062. Thus, a smaller amount of the released developer is likely to flow out of the developing device.

In the structure with the charging film 53 in FIG. 8C, when the length of the film support 54 is set so that the range of a magnetic brush 61a corresponds to the substantially entire range of the film support 54, the released developer is easily collected by an electric field between the charging film 53 and the developing sleeve 52.

When the length of a charging film 53′ is increased to a range in which the magnetic brush 61a does not come into contact with the charging film 53′ in FIG. 8D, a non-frictional slide area 62 is present. The non-frictional slide area 62 is charged though the voltage is lower than that of a frictional slide area 63. The charging polarity of the non-frictional slide area 62 is the same as that of the developer. Therefore, part of the magnetic brush 61a of the developer may be released by an electrostatic repulsive force.

Thus, the length of the charging film 53 may be set to a length associated with the width of the frictional slide area 63 to reduce the non-frictional slide area 62.

The range of the developer that frictionally slides against the charging film 53 changes depending on the positions of the magnetic poles S1 and N3 and the clearance between the charging film 53 and the developing sleeve 52. The centrifugal force increases as the circumferential speed of the developing sleeve 52 increases. Therefore, a large amount of the developer is likely to be released and fly in the developing area Q2k. The developer carried on the developing sleeve 52 is likely to have a long magnetic brush. Thus, the frictional slide range may be increased to increase the collection performance to address the increase in the amount of the released developer as the circumferential speed of the developing sleeve 52 increases. Further, the frictional slide range may be increased because the magnetic brush is likely to be long. Thus, the length of the charging film 53 may be increased as the circumferential speed of the developing sleeve 52 increases.

At the same number of rotations and angular velocity of a motor, the circumferential speed increases as the diameter of the developing sleeve 52 increases. Thus, the length of the charging film 53 may be increased as the diameter increases.

As described above, the magnetic brush is likely to become shorter as the charging film 53 is positioned farther away from the magnetic poles S1 and N3. As the charging film 53 is farther away from the magnetic poles S1 and N3, the developer is more unlikely to frictionally slide. Thus, the length of the charging film 53 may be reduced as the charging film 53 is positioned farther away from the magnetic poles S1 and N3. In other words, the length of the charging film 53 may be increased as the charging film 53 is closer to the magnetic poles S1 and N3. In a case where the charging film 53 is only positioned away from the magnetic poles S1 and N3, the length of the charging film 53 may be increased while reducing the clearance from the developing sleeve 52 to facilitate the frictional slide, thereby increasing the collection performance for the released developer.

The magnetic brush is likely to become shorter as the magnetic forces of the magnetic poles S1 and N3 decrease. As in the case where the charging film 53 is positioned away from the magnetic poles S1 and N3, the length of the charging film 53 may be reduced as the magnetic forces of the magnetic poles S1 and N3 decrease. In other words, the length of the charging film 53 may be increased as the magnetic forces of the magnetic poles S1 and N3 increase. In a case where the magnetic forces of the magnetic poles S1 and N3 are not increased, the length of the charging film 53 may be increased while reducing the clearance from the developing sleeve 52 to facilitate the frictional slide, thereby increasing the collection performance for the released developer.

### First Modification of Exemplary Embodiment

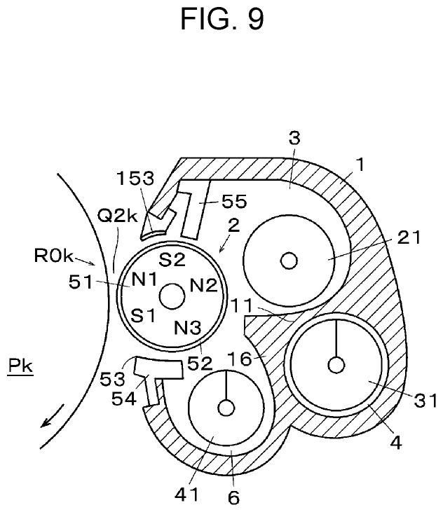

FIG. 9 illustrates a first modification of the exemplary embodiment in which the facing member is disposed on the upstream side of the developing area.

In the developing device Gk of the first modification of the exemplary embodiment in FIG. 9, a charging film 153 is disposed between the developing area Q2k and the trimmer 55 on the upstream side of the developing area Q2k.

### Second Modification of Exemplary Embodiment

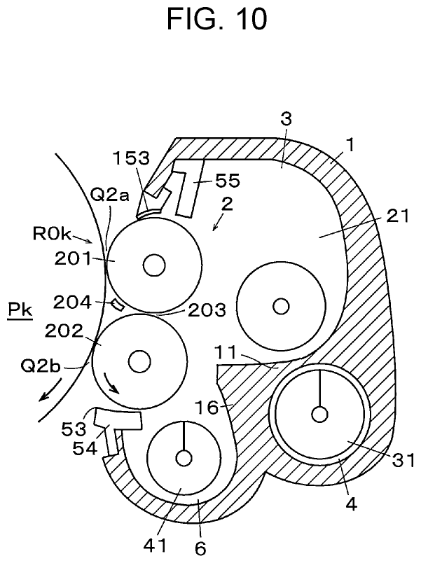

FIG. 10 illustrates a second modification of the exemplary embodiment.

Unlike the developing device Gk of the exemplary embodiment including the single developing roller R0K, the developing device Gk of the second modification of the exemplary embodiment in FIG. 10 includes a first developing roller 201 that is an example of a first developer carrier, and a second developing roller 202 that is an example of a second developer carrier. The first developing roller 201 is disposed on the upstream side and the second developing roller 202 is disposed on the downstream side along the rotational direction of the photoconductor drum Pk.

The developer is supplied to the first developing roller 201 from the supply chamber 3. The first developing roller 201 supplies the developer to the photoconductor drum Pk in a first developing area Q2a where the first developing roller 201 faces the photoconductor drum Pk. The first developing roller 201 that has passed through the first developing area Q2a passes the developer to the second developing roller 202 in a passing area 203 where the first developing roller 201 faces the second developing roller 202. The second developing roller 202 supplies the developer to the photoconductor drum Pk in a second developing area Q2b where the second developing roller 202 faces the photoconductor drum Pk. The second developing roller 202 that has passed through the second developing area Q2b returns the developer to the return chamber 6.

In the developing device Gk of the second modification of the exemplary embodiment, a first charging film 153 that is an example of a first facing component is disposed on the upstream side relative to the first developing area Q2a in the rotational direction of the first developing roller 201 as in the first modification of the exemplary embodiment. A second charging film 53 that is an example of a second facing component is disposed on the downstream side relative to the second developing area Q2b in the rotational direction of the second developing roller 202 as in the exemplary embodiment.

A third charging film 204 that is an example of a third facing component is disposed near the photoconductor drum Pk relative to the passing area 203. In the second modification of the exemplary embodiment, the third charging film 204 faces the first developing roller 201. The third charging film 204 may face not only the first developing roller 201 but also the second developing roller 202, or two third charging films 204 may be disposed in association with the two developing rollers 201 and 202.

The lengths of the charging films 53, 153, and 204 are set to lengths associated with the frictional slide ranges of the developer. In a case where the circumferential speeds of the first developing roller 201 and the second developing roller 202 differ from each other due to a difference in diameters etc., the lengths of the charging films 53, 153, and 204 may be set to different lengths.

In the second modification of the exemplary embodiment, the developer flying on the upstream side relative to the first developing area Q2a may be collected by the first charging film 153. The developer flying on the downstream side relative to the second developing area Q2b may be collected by the second charging film 53.

In the second modification of the exemplary embodiment, the third charging film 204 is disposed at the position corresponding to the passing area 203. Thus, the developer released when passed in the passing area 203 may be collected by the third charging film 204. The third charging film 204 may be omitted.

### Modifications

Modifications (H01) to (H05) of the exemplary embodiment of the present disclosure are described below.

(H01) In the exemplary embodiment, the copying machine U is provided as the example of the image forming apparatus. The image forming apparatus may be a FAX machine or a multifunction peripheral having a plurality of functions of a FAX machine, a printer, and a copying machine. The image forming apparatus is not limited to the multicolor-development image forming apparatus, and may be a monochrome image forming apparatus. Further, any electronic or mechanical apparatus using motors and gears may be an alternative to the image forming apparatus.

(H02) In the exemplary embodiment, the intermediate transfer belt B is provided as the example of the image carrier. The image carrier may be the photoconductor etc. The image carrier is not limited to the belt-shaped member, and may be a drum-shaped member.

(H03) In the exemplary embodiment, the facing component has the film shape, but the shape is not limited. For example, the facing component may have a solid shape (block shape) or any other shape.

(H04) In the first and second modifications, the downstream charging film 53 may be omitted.

(H05) In the exemplary embodiment, the charging films 53, 153, and 204 may be omitted.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A developing device comprising:
a developer container that contains a developer;
a developer carrier supported by the developer container and configured to carry the developer on a surface of the developer carrier;
a first transporter configured to transport the developer in the developer container, disposed parallel to the developer carrier, and configured to supply the developer to the developer carrier;
a second transporter configured to transport the developer in the developer container, disposed parallel to the first transporter, and configured to transport the developer in a direction opposite to a direction of the first transporter;
a third transporter configured to transport the developer in the developer container, disposed parallel to the second transporter, and configured to transport the developer released from the developer carrier;
a first container that contains the developer to be transported by the first transporter;
a second container that contains the developer to be transported by the second transporter;
a third container that contains the developer to be transported by the third transporter;
a first partition that is disposed between the first container and the second container and separates the first container and the second container;
a second partition that is disposed between the second container and the third container and separates the second container and the third container;
a first inlet portion disposed on an upstream side of the first partition in a transport direction of the first transporter and configured to cause the developer to flow into the first container from the second container;
a second inlet portion disposed on an upstream side of the first partition in a transport direction of the second transporter and configured to cause the developer to flow into the second container from the first container; and
a third inlet portion disposed on an upstream side of the second partition in the transport direction of the second transporter and configured to cause the developer to flow into the second container from the third container.
   (((2)))

The developing device according to (((1))), wherein a downstream end of the third inlet portion in the transport direction of the second transporter is positioned on an upstream side relative to a downstream end of the second inlet portion.

(((3)))

The developing device according to (((1))), wherein the third inlet portion is positioned on an upstream part of an inflow range of the second inlet portion in the transport direction of the second transporter.

(((4)))

The developing device according to (((1))), wherein the third inlet portion does not overlap a downstream part of an inflow range of the second inlet portion in the transport direction of the second transporter.

(((5)))

The developing device according to any one of (((1))) to (((4))), further comprising a fourth inlet portion disposed at a position corresponding to the third inlet portion and configured to cause a developer for replenishment to flow into the developer container.

(((6)))

The developing device according to any one of (((1))) to (((4))), further comprising a fourth inlet portion configured to cause a developer for replenishment to flow into the developer container,
wherein a downstream end of the fourth inlet portion is positioned on an upstream side relative to a downstream end of the second inlet portion.
   (((7)))

An image forming apparatus comprising:
an image carrier;
the developing device according to any one of (((1))) to (((6))) configured to develop an image on the image carrier;
a transferrer configured to transfer the image developed by the developing device onto a medium from the image carrier; and
a fixer configured to fix the image transferred onto the medium.

What is claimed is:

1. A developing device comprising:
a developer container that contains a developer;
a developer carrier supported by the developer container and configured to carry the developer on a surface of the developer carrier;
a first transporter configured to transport the developer in the developer container, disposed parallel to the developer carrier, and configured to supply the developer to the developer carrier;
a second transporter configured to transport the developer in the developer container, disposed parallel to the first transporter, and configured to transport the developer in a direction opposite to a direction of the first transporter;
a third transporter configured to transport the developer in the developer container, disposed parallel to the second transporter, and configured to transport the developer released from the developer carrier;
a first container that contains the developer to be transported by the first transporter;
a second container that contains the developer to be transported by the second transporter;
a third container that contains the developer to be transported by the third transporter;
a first partition that is disposed between the first container and the second container and separates the first container and the second container;
a second partition that is disposed between the second container and the third container and separates the second container and the third container;
a first inlet portion disposed on an upstream side of the first partition in a transport direction of the first transporter and configured to cause the developer to flow into the first container from the second container;
a second inlet portion disposed on an upstream side of the first partition in a transport direction of the second transporter and configured to cause the developer to flow into the second container from the first container; and
a third inlet portion disposed on an upstream side of the second partition in the transport direction of the second transporter and configured to cause the developer to flow into the second container from the third container.

2. The developing device according to claim 1, wherein a downstream end of the third inlet portion in the transport direction of the second transporter is positioned on an upstream side relative to a downstream end of the second inlet portion.

3. The developing device according to claim 1, wherein the third inlet portion is positioned on an upstream part of an inflow range of the second inlet portion in the transport direction of the second transporter.

4. The developing device according to claim 1, wherein the third inlet portion does not overlap a downstream part of an inflow range of the second inlet portion in the transport direction of the second transporter.

5. The developing device according to claim 1, further comprising a fourth inlet portion disposed at a position corresponding to the third inlet portion and configured to cause a developer for replenishment to flow into the developer container.

6. The developing device according to claim 1, further comprising a fourth inlet portion configured to cause a developer for replenishment to flow into the developer container,
wherein a downstream end of the fourth inlet portion is positioned on an upstream side relative to a downstream end of the second inlet portion.

7. An image forming apparatus comprising:
an image carrier;
the developing device according to claim 1 configured to develop an image on the image carrier;
a transferrer configured to transfer the image developed by the developing device onto a medium from the image carrier; and
a fixer configured to fix the image transferred onto the medium.

8. An image forming apparatus comprising:
an image carrier;
the developing device according to claim 2 configured to develop an image on the image carrier;
a transferrer configured to transfer the image developed by the developing device onto a medium from the image carrier; and
a fixer configured to fix the image transferred onto the medium.

9. An image forming apparatus comprising:
an image carrier;
the developing device according to claim 3 configured to develop an image on the image carrier;
a transferrer configured to transfer the image developed by the developing device onto a medium from the image carrier; and
a fixer configured to fix the image transferred onto the medium.

10. An image forming apparatus comprising:
an image carrier;
the developing device according to claim 4 configured to develop an image on the image carrier;
a transferrer configured to transfer the image developed by the developing device onto a medium from the image carrier; and
a fixer configured to fix the image transferred onto the medium.

11. An image forming apparatus comprising:
an image carrier;
the developing device according to claim 5 configured to develop an image on the image carrier;
a transferrer configured to transfer the image developed by the developing device onto a medium from the image carrier; and
a fixer configured to fix the image transferred onto the medium.

12. An image forming apparatus comprising:
an image carrier;
the developing device according to claim 6 configured to develop an image on the image carrier;
a transferrer configured to transfer the image developed by the developing device onto a medium from the image carrier; and
a fixer configured to fix the image transferred onto the medium.

13. A developing device comprising:
developer containing means for containing a developer;
developer carrying means for carrying the developer on a surface of the developer carrying means, the developer carrying means being supported by the developer containing means;
first transport means for transporting the developer in the developer containing means and supplying the developer to the developer carrying means, the first transport means being disposed parallel to the developer carrying means;
second transport means for transporting the developer in the developer containing means and transporting the developer in a direction opposite to a direction of the first transport means, the second transporter means being disposed parallel to the first transport means;
third transport means for transporting the developer in the developer containing means and transporting the developer released from the developer carrying means, the third transport means being disposed parallel to the second transport means;
first containing means for containing the developer to be transported by the first transport means;
second containing means for containing the developer to be transported by the second transport means;
third containing means for containing the developer to be transported by the third transport means;
first partition means for separating the first containing means and the second containing means, the first partition means being disposed between the first containing means and the second containing means;
second partition means for separating the second containing means and the third containing means, the second partition means being disposed between the second containing means and the third containing means;
first inlet means for causing the developer to flow into the first containing means from the second containing means, the first inlet means being disposed on an upstream side of the first partition means in a transport direction of the first transport means;
second inlet means for causing the developer to flow into the second containing means from the first containing means, the second inlet means being disposed on an upstream side of the first partition means in a transport direction of the second transport means; and
third inlet means for causing the developer to flow into the second containing means from the third containing means, the third inlet means being disposed on an upstream side of the second partition means in the transport direction of the second transport means.
